(19) United States
(12) Patent Application Publication
(10) Pub. No.: US 2025/0008597 A1
(43) Pub. Date: Jan. 2, 2025

(54) METHOD AND APPARATUS FOR ENHANCED DISCONTINUOUS RECEPTION OPERATION IN MOBILE COMMUNICATIONS

(71) Applicant: MediaTek Singapore Pte. Ltd., Singapore (SG)

(72) Inventors: Mehmet KUNT, Cambridge (GB); Abdellatif SALAH, Cambridge (GB); Pradeep JOSE, Cambridge (GB)

(21) Appl. No.: 18/703,988

(22) PCT Filed: Nov. 24, 2022
(86) PCT No.: PCT/CN2022/134153

§ 371 Date: Apr. 23, 2024

Related U.S. Application Data
(60) Provisional application No. 63/283,243, filed on Nov. 25, 2021.

(51) Int. Cl. H04W 76/28; H04L 5/00; H04W 72/23

(52) U.S. Cl. CPC H04W 76/28; H04L 5/0007; H04W 72/23

(57) ABSTRACT

Various solutions for discontinuous reception (DRX) operation for extended reality (XR) and cloud gaming traffic with respect to user equipment and network apparatus in mobile communications are proposed. An apparatus may receive a downlink control information (DCI) or a downlink (DL) media access control (MAC) control element (MAC CE). The apparatus may obtain a DRX start offset from the DCI or the DL MAC CE. The apparatus may adjust a start time of an on-duration of a DRX cycle dynamically according to the DRX start offset. The apparatus may monitor a PDCCH transmitted from a network node during the adjusted on-duration.

### CROSS REFERENCE TO RELATED PATENT APPLICATION(S)

The present disclosure is part of a non-provisional application claiming the priority benefit of U.S. Provisional Patent Application No. U.S. 63/283,243, filed 25 Nov. 2021, the content of which being incorporated by reference in its entirety.

### TECHNICAL FIELD

The present disclosure is generally related to mobile communications and, more particularly, to enhanced discontinuous reception (DRX) operation for extended reality (XR) and cloud gaming traffic with respect to user equipment and network apparatus in mobile communications.

### BACKGROUND

Unless otherwise indicated herein, approaches described in this section are not prior art to the claims listed below and are not admitted as prior art by inclusion in this section.

In current New Radio (NR) framework, 3^{rd} Generation Partnership Project (3GPP) Release 15 (Rel-15) and Release 16 (Rel-16) specified connected mode discontinuous reception (cDRX) operation which allows for UE power saving by switching off the UE transmit (Tx)/receive (Rx) chains when there is no data to be received from the base station or to be transmitted by the UE. The UE can be configured a DRX cycle comprising an on-duration and an off-duration with a periodicity. The UE may wake up within the on-duration for data reception/transmission and go to sleep within the off-duration for power saving. One of the limitations/challenges of the Rel-15/Rel-16 cDRX design when applied to the XR/cloud gaming traffic is that the existing cDRX periodicities do not align with the augmented reality (AR)/virtual reality (VR) periodicities. The data burst of AR/VR traffic could be mismatched with the on-duration of DRX cycle.

In addition, the AR/VR traffic modelling introduced a jitter which means that the traffic is not exactly periodic, but the arrival could be random within a specific jitter interval (e.g., [−4, +4] millisecond (ms) for downlink (DL) AR/VR). Some data may come early, and some data may be delayed. One straightforward but costly solution is to force the UE to wake up more frequently, but then the power consumption gain is compromised. The UE may waste power due to the uncertainties. The power performance and user experience will become bad.

Accordingly, how to improve the DRX operations for adapting to audio/video streams for XR and/or cloud gaming traffic becomes an important issue for UE power saving in the newly developed wireless communication network. Therefore, there is a need to provide proper schemes to perform DRX operations for XR and/or cloud gaming applications.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to enhanced DRX operation for XR and cloud gaming traffic with respect to user equipment and network apparatus in mobile communications.

In one aspect, a method may involve an apparatus receiving a downlink control information (DCI) or a DL media access control (MAC) control element (MAC CE). The method may involve the apparatus obtaining a DRX start offset from the DCI or the DL MAC CE. The method may also involve the apparatus adjusting a start time of an on-duration of a DRX cycle dynamically according to the DRX start offset. The method may further involve the apparatus monitoring a Physical Downlink Control Channel (PDCCH) transmitted from a network node during the adjusted on-duration.

In one aspect, a method may involve an apparatus receiving a DCI or a DL MAC CE. The method may involve the apparatus obtaining on-duration information from the DCI or the DL MAC CE. The method may also involve the apparatus adjusting a length of an on-duration of a DRX cycle dynamically according to the on-duration information. The method may further involve the apparatus monitoring a PDCCH transmitted from a network node during the adjusted on-duration.

In one aspect, a method may involve an apparatus receiving a DCI or a DL MAC CE indicating a timer information for adjusting a timer. The method may involve the apparatus obtaining the timer information from the DCI or the DL MAC CE. The method may also involve the apparatus adjusting a timer of a DRX operation dynamically according to the timer information. The method may further involve the apparatus monitoring a PDCCH transmitted from a network node according to the adjusted timer. The timer may comprise a DRX retransmission timer or a DRX inactivity timer

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Extended reality (XR), cloud gaming, Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario under schemes in accordance with implementations of the present disclosure.

FIG. 2 is a diagram depicting an example scenario under schemes in accordance with implementations of the present disclosure.

FIG. 3 is a diagram depicting example scenarios under schemes in accordance with implementations of the present disclosure.

FIG. 4 is a diagram depicting example scenarios under schemes in accordance with implementations of the present disclosure.

FIG. 5 is a diagram depicting an example scenario under schemes in accordance with implementations of the present disclosure.

FIG. 6 is a block diagram of an example communication system in accordance with an implementation of the present disclosure.

FIG. 7 is a flowchart of an example process in accordance with an implementation of the present disclosure.

FIG. 8 is a flowchart of an example process in accordance with an implementation of the present disclosure.

FIG. 9 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to enhanced DRX operation for XR and cloud gaming traffic with respect to user equipment (UE) and network apparatus in mobile communications. According to the present disclosure, a number of possible solutions may be implemented separately or jointly. That is, although these possible solutions may be described below separately, two or more of these possible solutions may be implemented in one combination or another.

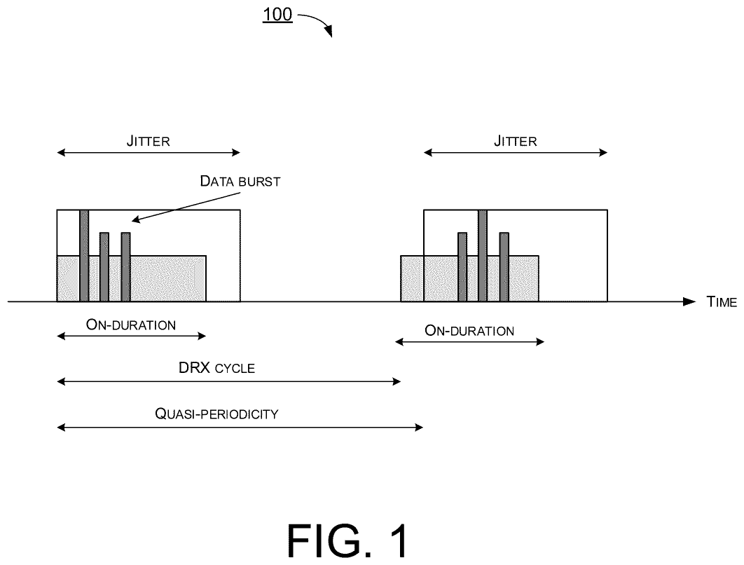

FIG. 1 illustrates an example scenario 100 under schemes in accordance with implementations of the present disclosure. Scenario 100 involves at least a UE and a network node, which may be a part of a wireless communication network (e.g., an LTE network, a 5G/NR network, an IoT network). The UE is configured by the network node with a DRX configuration. The DRX configuration may comprise a DRX cycle and an on-duration. The UE may further be configured to receive XR/cloud gaming traffic with a quasi-periodicity. Quasi-periodicity means that the traffic is not exactly periodic. Sometimes the traffic may come early, and sometimes the traffic may come later. The burst depends on the scenarios of the XR/cloud gaming applications. There are no clear/specific/fixed boundaries for the traffic arrival time.

One of the issues when applying DRX operation on XR traffic is that the DRX cycle mismatch with the quasi-periodic XR traffic. As shown in FIG. 1, legacy DRX cycle values do not match the quasi-periodicity of XR traffic. The quasi-periodicity of XR traffic could be longer or shorter than the periodicity of DRX cycle. Over time, the difference can build up and on-duration of DRX cycle could be completely outside of (i.e., out-of-sync with) the burst arrival period. The burst could arrive in the off duration of DRX cycle. The UE may partially or completely miss the burst.

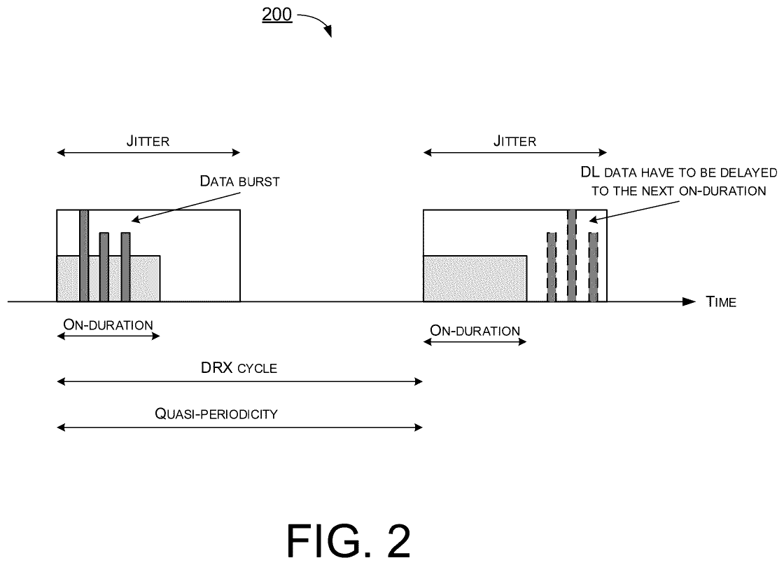

FIG. 2 illustrates an example scenario 200 under schemes in accordance with implementations of the present disclosure. Scenario 200 involves at least a UE and a network node, which may be a part of a wireless communication network (e.g., an LTE network, a 5G/NR network, an IoT network). Another issue when applying DRX operation on XR traffic is that jitter can occupy a large time interval (e.g., [−4, +4] ms for XR traffic). Jitter is the timer interval that burst may arrive. Since the data packets for video/audio streams are large, the transmitter (e.g., XR server/network node) needs to perform data compression to reduce the packet size. Such data compression may cause different delay time on the data packets. Therefore, the time period of jitter could be long and uncertain.

Thus, even if the DRX cycle mismatch issue is resolved, covering the whole jitter period with on-duration could have a large impact on the UE power consumption. The UE needs to wake up for a longer time for covering the whole jitter period which leads to significant UE power consumption. On the other hand, if the on-duration is smaller than jitter, some DL data might be delayed until the next on-duration. The data reception performance will become worse. Therefore, there is a need to provide some DRX operation enhancement schemes for XR/cloud gaming traffic.

In view of the above, the present disclosure proposes several schemes pertaining to enhanced DRX operation for XR and cloud gaming traffic with respect to user equipment and network apparatus in mobile communications. According to the schemes of the present disclosure, some dynamic adjustments on DRX configurations may be introduced to resolve the aforementioned issues. For example, the start of the on-duration/active time for DRX operation may be dynamically adjusted. In addition, the length of the on-duration/active time for DRX operation may be dynamically adjusted. Other parameters like retransmission timer and inactivity timer in the DRX configuration may also be dynamically adjusted. Thus, the on-duration/active time of the DRX operation may be dynamically adapted to accommodate the uncertainties of the XR/cloud gaming traffic. Accordingly, the UE power consumption can be well controlled by the enhanced DRX operation without compromise on data reception/transmission performance. The user experiences and UE power performance can be improved.

The DRX active time may be determined according to the definitions in 3GPP. For example, when DRX is configured, the active time for serving cells in a DRX group includes the time while drx-onDurationTimer or drx-InactivityTimer configured for the DRX group is running, drx-RetransmissionTimerDL or drx-RetransmissionTimerUL is running on any Serving Cell in the DRX group, ra-ContentionResolutionTimer or msgB-ResponseWindow is running, a Scheduling Request is sent on physical uplink control channel (PUCCH) and is pending, or a PDCCH indicating a new transmission addressed to the Cell-RadioNetworkTemporaryIdentifier (C-RNTI) of the Media Access Control (MAC) entity has not been received after successful reception of a Random Access Response for the Random Access Preamble not selected by the MAC entity among the contention-based Random Access Preamble.

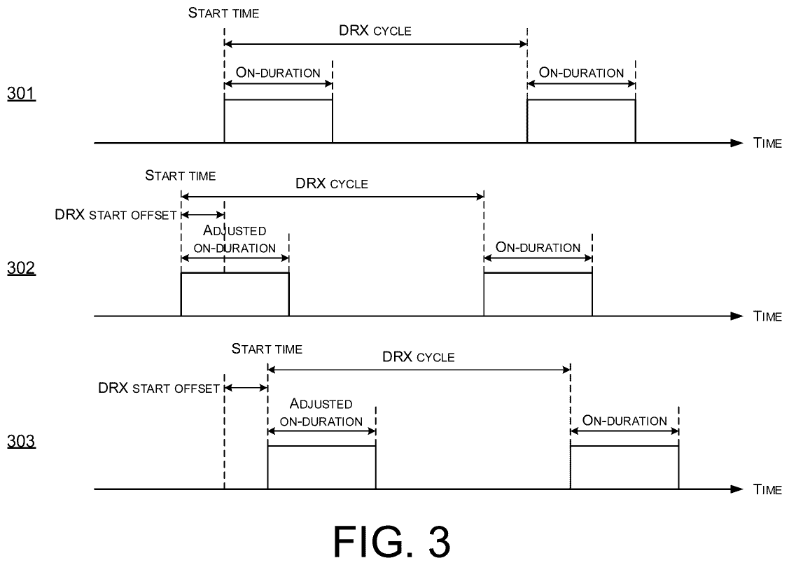

FIG. 3 illustrates example scenarios 301, 302 and 303 under schemes in accordance with implementations of the present disclosure. Scenarios 301, 302 and 303 involve at least a UE and a network node, which may be a part of a wireless communication network (e.g., an LTE network, a 5G/NR network, an IoT network or a 6G network). FIG. 3 illustrates examples of dynamically adjusting the start offset of the on-duration for DRX operation. The UE may obtain a DRX start offset. The UE may adjust a start time of an on-duration of a DRX cycle dynamically according to the DRX start offset. Then, the UE may monitor a PDCCH transmitted from a network node during the adjusted on-duration. The PDCCH may indicate DL or uplink (UL) data for a stream. The stream may comprise at least one of an XR stream, a cloud gaming stream and a video/audio stream.

In scenario 301, the UE is configured a DRX configuration. The DRX configuration may comprise a DRX cycle, an on-duration and a start time of the on-duration. In scenario 302, the UE may be configured a DRX start offset. The DRX start offset may indicate the UE to shift the start time of the on-duration earlier (e.g., packets may come earlier). Then, the UE adjusts the start time of the on-duration according to the DRX start offset. After the adjustment, the UE can receive the earlier packets during the adjusted on-duration. Similarly, in scenario 303, the UE may be configured a DRX start offset. The DRX start offset may indicate the UE to delay the start time of the on-duration (e.g., packets may be delayed). Then, the UE adjusts the start time of the on-duration according to the DRX start offset. After the adjustment, the UE can receive the delayed packets of the stream during the adjusted on-duration.

Specifically, the base station (e.g., gNB) or the XR server can predict or have prior knowledge about the next DRX start offset for the next video frame. The base station or the XR server can signal the next DRX start offset to the UE in advance in a transmitted physical downlink shared channel (PDSCH) together with the data packet of a video frame by multiplexing or piggybacking or in a PDCCH. For example, the last data packet of the data burst may contain information about the next data burst (e.g., DRX start offset, data duration, priority level, etc.).

The DRX start offset may be signaled by the base station or the XR server dynamically. For example, the base station or the XR server may use a downlink control information (DCI) bit-field (e.g., a new field or an existing field in DCI) to dynamically signal the DRX start offset. The DCI format used for signaling may comprise a DCI format for scheduling PDSCH (e.g., DCI format 1_0, DCI format 1_1 or DCI format 1_2), a DCI format for other purposes, (e.g., DCI format 2_0 or DCI format 2_1), a DCI format for schedule PUSCH (e.g., DCI format 0_0, DCI format 0_1 or DCI format 0_2), or a new DCI format. The UE may receive the DCI and obtain the DRX start offset from the DCI. In some implementations, a downlink (DL) media access control (MAC) control element (MAC CE) may be used to indicate the DRX start offset. The UE may receive the DL MAC CE and obtain the DRX start offset from the DL MAC CE. The UE may dynamically adjust the start time of the on-duration according to the DRX start offset.

In some implementations, the base station or the XR server may not directly indicate the DRX start offset in the DCI. To be more specific, a DRX start offset look-up table could be specified or configured to the UE. The DRX start offset look-up table may comprise multiple DRX start offsets. Each of the DRX start offsets may correspond to an index. The base station or the XR server may use the DCI to indicate one of the indexes. After receiving the DCI, the UE may obtain the DRX start offset from the DRX start offset look-up table according to the index. The DRX start offset look-up table may be pre-configured by a network node or pre-stored in the UE.

In some implementations, the DRX start offset may be defined in an interval [X, Y]. The values of X and Y may be defined by an integer or parameters. For example, the DRX start offset may be configured by [0, +DRX-cycle], [−DRX-cycle, +DRX-cycle], [0, +max_jitter], [−max_jitter, +max_jitter], etc.

In some implementations, the base station or the XR server may use a bit-field or an extra/new bit in DCI to indicate a sign of the DRX start offset. For instance, a negative sign indicates the UE to start the on-duration earlier, and a positive sign indicates the UE to start the on-duration later. In addition, the indication (e.g., DCI, MAC CE, etc.) may further inform the UE whether it can go to sleep or not (with/without signalling the DRX start offset). Alternatively, there may be separate indications for indicating DRX start offset for the next on-duration/active time and indicating go to sleep (at the end of current on-duration/active time).

In some implementations, the DRX start offset may be relative to current on-duration of the DRX cycle/active time (e.g., the shift corresponding to the DRX start offset is cumulative and applies to all the following on-durations/active times). Alternatively, the DRX start offset may be relative to current DRX configuration for on-duration (e.g., the shift corresponding to the DRX start offset is one-off and applies only to the next on-duration/active time).

A DRX start offset granularity can be specified or configured by the network node (e.g., the base station or the XR server). The granularity of the DRX start offset may comprise at least one of a time duration (e.g., 1 ms), a slot, a sub-slot, an orthogonal frequency division multiplexing (OFDM) symbol, and a fraction of the DRX cycle (e.g., ¼, ⅛, etc.).

To avoid the problem of missed indication (e.g., missed DCI, missed PDSCH, etc.) for the DRX start offset, the UE can acknowledge the reception of the DRX start offset indication. In an event that the UE receives the indication of the DRX start offset, the UE may transmit an acknowledgement (ACK) in response to obtaining the DRX start offset. The acknowledgement may be transmitted via one of uplink control information (UCI) and an uplink (UL) MAC CE.

If DRX start offset indication is missed by the UE, a fall-back operation may be performed. The fall-back operation may comprise, for example but not limited to, using existing DRX start offset, using the earliest DRX start offset (i.e., impact on power), or using a default DRX start offset, where the default DRX start offset can be specified in 3GPP specifications or configured by the base station or the XR server. The network node may attempt to update the DRX start offset at the next on-duration or active time (i.e., impact on latency).

If UE acknowledgement is missed by the network node, a fall-back operation may be performed. The fall-back operation may comprise that, for example but not limited to, network node may schedule the UE in DL assuming the worst case (e.g., longest sleep duration, shortest on-duration, etc.) and using the largest of the two DRX start offsets (e.g., signalled DRX start offset and default DRX start offset).

If on-duration grouping (e.g., bundling) is used, all or a number of DCIs during the current on-duration group may indicate the DRX start offset for the next on-duration group. This could reduce the chances of missed DCI. Alternatively, the MAC CE may be repeated in multiple PDSCHs within the on-duration group.

In some implementations, the length of the on-Duration may be fixed, and the start time may be modified/adjusted by the DRX start offset. Alternatively, the end time of the on-Duration may be fixed, and the start time may be modified/adjusted by the DRX start offset. This may result in variable length for the on-duration based on the start time offset.

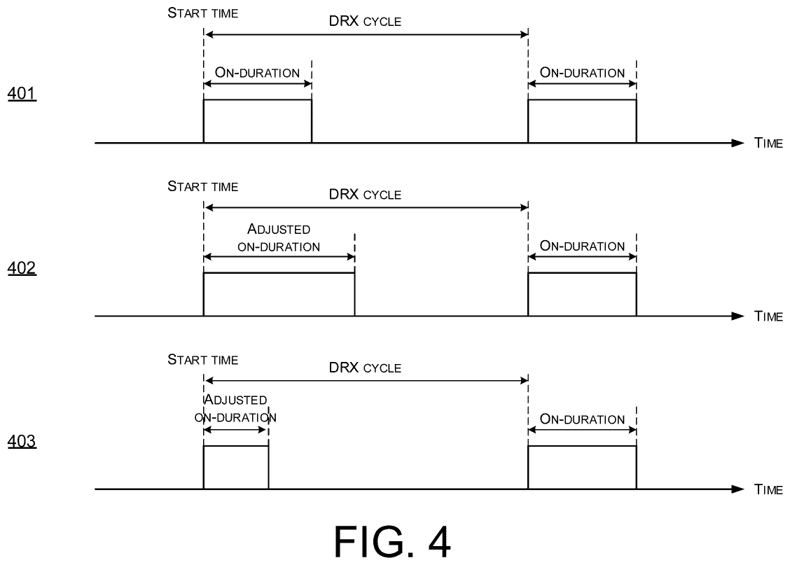

FIG. 4 illustrates example scenarios 401, 402 and 403 under schemes in accordance with implementations of the present disclosure. Scenarios 401, 402 and 403 involve at least a UE and a network node, which may be a part of a wireless communication network (e.g., an LTE network, a 5G/NR network, an IoT network or a 6G network). FIG. 4 illustrates examples of dynamically adjusting the length of the on-duration for DRX operation. The UE may obtain on-duration information. The UE may adjust a length of an on-duration of a DRX cycle dynamically according to the on-duration information. Then, the UE may monitor a PDCCH transmitted from a network node during the adjusted on-duration. The PDCCH may indicate DL or UL data for a stream. The stream may comprise at least one of an XR stream, a cloud gaming stream and a video/audio stream.

In scenario 401, the UE is configured a DRX configuration. The DRX configuration may comprise a DRX cycle, an on-duration and a length of the on-duration. In scenario 402, the UE may be configured an on-duration information. The on-duration information may indicate a longer length for the on-duration (e.g., the size of the next video frame is greater). Then, the UE adjusts the length of the on-duration according to the on-duration information. After the adjustment, the UE can monitor the PDCCH during the adjusted on-duration. Similarly, in scenario 403, the UE may be configured an on-duration information. The on-duration information may indicate a shorter length for the on-duration (e.g., the size of the next video frame is smaller). Then, the UE adjusts the length of the on-duration according to the on-duration information. After the adjustment, the UE can monitor the PDCCH during the adjusted on-duration.

Specifically, base station (e.g., gNB) or the XR server can predict or have prior knowledge about the size of the next video frame. The base station or the XR server can dynamically signal DRX on-duration information to the UE in advance in a transmitted PDSCH together with the data packet of a video frame or in a PDCCH. The on-duration information includes an on-duration timer (e.g., drx-onDurationTimer). The drx-onDurationTimer may define the duration at the beginning of a DRX cycle.

The base station or the XR server may use a DCI bit-field to dynamically signal the on-duration information. The UE may receive the DCI and obtain the on-duration information from the DCI. In other implementations, the base station or the XR server may use a DL MAC CE to signal the on-duration information. The UE may receive the DL MAC CE and obtain the on-duration information from the DL MAC CE.

In some implementations, the DCI may be a first DCI in the on-duration. The first DCI may indicate the length of the on-duration. For example, the first DCI in the on-duration of DRX cycle may indicate the length of the current on-duration. In some implementations, the DCI may be a last DCI in a previous on-duration. The last DCI may indicate the length of the on-duration. For example, the last DCI in the previous on-duration may indicate the length of the current on-duration.

In some implementations, the UE may receive a plurality of data packets in a video burst and obtain the on-duration information from the last data packet of the data packets. In other words, the last data packet of the video burst contains information about the next on-duration of the DRX cycle.

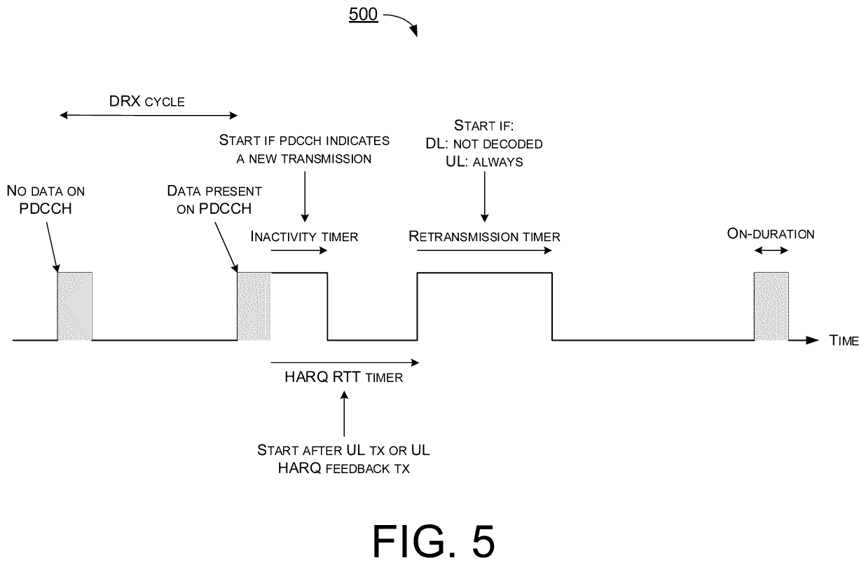

FIG. 5 illustrates example scenario 500 under schemes in accordance with implementations of the present disclosure. Scenario 500 involves at least a UE and a network node, which may be a part of a wireless communication network (e.g., an LTE network, a 5G/NR network, an IoT network or a 6G network). FIG. 5 illustrates an example of dynamically adjusting timer parameters in a DRX configuration. The UE may obtain timer information from the network node. The UE may adjust a timer of a DRX operation dynamically according to the timer information. The timer information may be relative to the current value of the timer or the value in the DRX configuration. The timer may comprise a retransmission timer (e.g., drx-RetransmissionTimerDL and/or drx-RetransmissionTimerUL) or an inactivity timer (e.g., drx-InactivityTimer). The drx-RetransmissionTimerDL may define the maximum duration until a DL retransmission is received. The drx-RetransmissionTimerUL may define the maximum duration until a grant for UL retransmission is received. The drx-InactivityTimer may define the duration after the PDCCH occasion in which a PDCCH indicates a new UL or DL transmission for the MAC entity. The UE may monitor a PDCCH transmitted from a network node according to the adjusted timer. The PDCCH may indicate DL or UL data for a stream. The stream may comprise at least one of an XR stream, a cloud gaming stream and a video/audio stream.

The base station or the XR server may signal the timer information by using DCI (e.g., a new DCI format or a new field in an existing DCI format) or DL MAC CE transmitted in PDSCH. The UE may receive the DCI or the DL MAC CE indicating the timer information for adjusting the timer and obtain the timer information from the DCI or the DL MAC CE.

In some implementations, the base station or the XR server may use a bit-field or an extra bit of DCI to indicate a sign of the timer adjustment (i.e., the timer information). For instance, a negative sign indicates the UE to start the timer earlier or increase the timer value, and a positive sign indicates the UE to start the timer later or decrease the timer value. The indication (e.g., DCI, MAC CE, etc.) may also inform the UE whether it can go to sleep or not (with/without signalling the timer information). Alternatively, there may be separate indications for indicating the timer information for adjusting the timer and indicating go to sleep.

A granularity of the timer information can be specified or configured by the network node (e.g., the base station or the XR server). The granularity of the timer information may comprise at least one of a time duration (e.g., 1 ms), a slot, a sub-slot, an OFDM symbol, and a fraction of the DRX cycle (e.g., ¼, ⅛, etc.).

To avoid the problem of missed indication (e.g., missed DCI, missed PDSCH, etc.) for the timer information, the UE can acknowledge the reception of the timer information. In an event that the UE receives the timer information, the UE may transmit an acknowledgement in response to obtaining the timer information. The acknowledgement mat be transmitted via one of UCI and an UL MAC CE transmitted in a PUSCH.

If parameter indication is missed by the UE, a fall-back operation may be performed. The fall-back operation may comprise, for example but not limited to, using the existing parameter, using the worst-case value (e.g., largest drx-RetransmissionTimerDL/UL or drx-InactivityTimer) or using a default value, where the default can be specified in 3GPP specifications or configured by network node. The network node may attempt to update the timer information at the next on-duration/active time.

If UE acknowledgement is missed by the network node, a fall-back operation may be performed. The fall-back operation may comprise that, for example but not limited to, the network node may schedule the UE in DL assuming the worst case (e.g., longest sleep duration, shortest on-duration, shortest drx-RetransmissionTimerDL/UL or drx-InactivityTimer, etc.).

### Illustrative Implementations

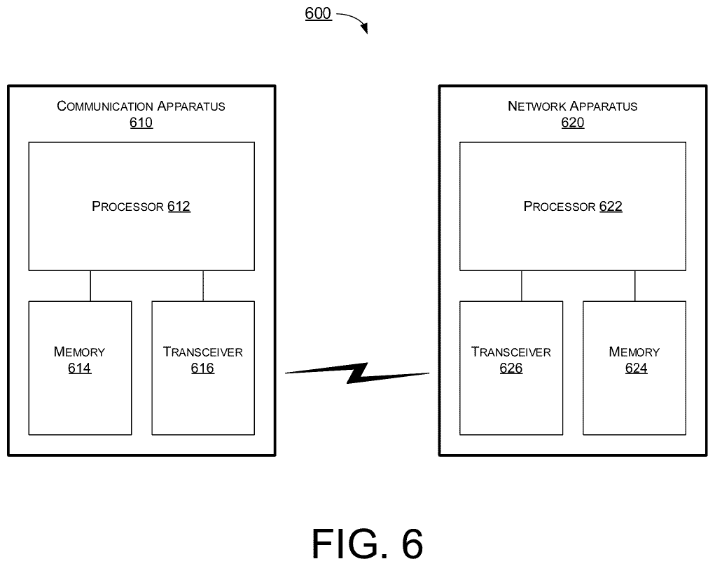

FIG. 6 illustrates an example communication system 600 having an example communication apparatus 610 and an example network apparatus 620 in accordance with an implementation of the present disclosure. Each of communication apparatus 610 and network apparatus 620 may perform various functions to implement schemes, techniques, processes and methods described herein pertaining to enhanced DRX operation for XR and cloud gaming traffic with respect to user equipment and network apparatus in wireless communications, including scenarios/schemes described above as well as processes 700, 800 and 900 described below.

Communication apparatus 610 may be a part of an electronic apparatus, which may be a UE such as a portable or mobile apparatus, a wearable apparatus, a wireless communication apparatus or a computing apparatus. For instance, communication apparatus 610 may be implemented in a smartphone, a smartwatch, a personal digital assistant, a digital camera, or a computing equipment such as a tablet computer, a laptop computer or a notebook computer. Communication apparatus 610 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 610 may be implemented in a smart thermostat, a smart fridge, a smart door lock, a wireless speaker or a home control center. Alternatively, communication apparatus 610 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 610 may include at least some of those components shown in FIG. 6 such as a processor 612, for example. Communication apparatus 610 may further include one or more other components not pertinent to the proposed scheme of the present disclosure (e.g., internal power supply, display device and/or user interface device), and, thus, such component(s) of communication apparatus 610 are neither shown in FIG. 6 nor described below in the interest of simplicity and brevity.

Network apparatus 620 may be a part of an electronic apparatus, which may be a network node such as a base station, a small cell, a router or a gateway. For instance, network apparatus 620 may be implemented in an eNodeB in an LTE, LTE-Advanced or LTE-Advanced Pro network or in a gNB in a 5G, NR, IoT, NB-IoT or IoT network. Alternatively, network apparatus 620 may be implemented in the form of one or more IC chips such as, for example and without limitation, one or more single-core processors, one or more multi-core processors, or one or more RISC or CISC processors. Network apparatus 620 may include at least some of those components shown in FIG. 6 such as a processor 622, for example. Network apparatus 620 may further include one or more other components not pertinent to the proposed scheme of the present disclosure (e.g., internal power supply, display device and/or user interface device), and, thus, such component(s) of network apparatus 620 are neither shown in FIG. 6 nor described below in the interest of simplicity and brevity.

In one aspect, each of processor 612 and processor 622 may be implemented in the form of one or more single-core processors, one or more multi-core processors, or one or more CISC processors. That is, even though a singular term “a processor” is used herein to refer to processor 612 and processor 622, each of processor 612 and processor 622 may include multiple processors in some implementations and a single processor in other implementations in accordance with the present disclosure. In another aspect, each of processor 612 and processor 622 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 612 and processor 622 is a special-purpose machine specifically designed, arranged and configured to perform specific tasks including enhanced DRX operation for XR and cloud gaming traffic with respect to user equipment and network apparatus in mobile communications in accordance with various implementations of the present disclosure.

In some implementations, communication apparatus 610 may also include a transceiver 616 coupled to processor 612 and capable of wirelessly transmitting and receiving data. In some implementations, communication apparatus 610 may further include a memory 614 coupled to processor 612 and capable of being accessed by processor 612 and storing data therein. In some implementations, network apparatus 620 may also include a transceiver 626 coupled to processor 622 and capable of wirelessly transmitting and receiving data. In some implementations, network apparatus 620 may further include a memory 624 coupled to processor 622 and capable of being accessed by processor 622 and storing data therein. Accordingly, communication apparatus 610 and network apparatus 620 may wirelessly communicate with each other via transceiver 616 and transceiver 626, respectively. To aid better understanding, the following description of the operations, functionalities and capabilities of each of communication apparatus 610 and network apparatus 620 is provided in the context of a mobile communication environment in which communication apparatus 610 is implemented in or as a communication apparatus or a UE and network apparatus 620 is implemented in or as a network node of a communication network.

Under various proposed schemes in accordance with the present disclosure pertaining to enhanced DRX operation for XR and cloud gaming traffic, processor 612 may receive, via transceiver 616, a DCI or a DL MAC CE and obtain a DRX start offset from the DCI or the DL MAC CE. Then, processor 612 may adjust a start time of an on-duration of a DRX cycle dynamically according to the DRX start offset. The processor 612 may monitor, via transceiver 616, a PDCCH transmitted from network apparatus 620 during the adjusted on-duration.

In some implementations, processor 612 may perform a fallback operation in an event that DCI or the DL MAC CE with the DRX start offset is missed. The fallback operation may comprise using an existing DRX start offset, an earliest DRX start offset or a default DRX start offset.

In some implementations, processor 612 may receive, via transceiver 616, DCI indicating an index of a DRX start offset look-up table and obtain the DRX start offset from the DRX start offset look-up table according to the index.

In some implementations, network apparatus 620 may configure a granularity of the DRX start offset. The granularity of the DRX start offset may comprise at least one of a time duration, a slot, a sub-slot, an OFDM symbol, and a fraction of the DRX cycle.

In some implementations, processor 612 may transmit, via transceiver 616, an acknowledgement in response to obtaining the DRX start offset. The acknowledgement may be transmitted via one of UCI and an UL MAC CE.

In some implementations, the DRX start offset may be relative to a current on-duration of the DRX cycle or a current DRX configuration for the on-duration.

In some implementations, the length of the on-duration or the end time of the on-duration is fixed.

Under various proposed schemes in accordance with the present disclosure pertaining to discontinuous reception operation for XR and cloud gaming traffic, processor 612 may receive, via transceiver 616, a DCI or a MAC CE and obtain an on-duration information from the DCI or the DL MAC CE. Processor 612 may adjust a length of an on-duration of a DRX cycle dynamically according to the on-duration information. Then, processor 612 may monitor, via transceiver 616, a PDCCH transmitted from a network node during the adjusted on-duration.

In some implementations, the on-duration information may comprise an on-duration timer.

In some implementations, network apparatus 620 may use a first DCI in the on-duration to indicate the length of the on-duration.

In some implementations, network apparatus 620 may use a last DCI in a precious on-duration to indicate the length of the on-duration.

In some implementations, processor 612 may receive, via transceiver 616, a plurality of data packets in a burst and obtain the on-duration information from the last data packet of the data packets.

Under various proposed scheme in accordance with the present disclosure pertaining to enhanced DRX operation for XR and cloud gaming traffic, processor 612 may receive, via transceiver 616, a DCI or a DL MAC CE indicating a timer information for adjusting a timer and obtain the timer information from the DCI or the DL MAC CE. Processor 612 may adjust a timer of a DRX operation dynamically according to the timer information. Then, processor 612 may monitor, via transceiver 616, a PDCCH transmitted from a network node according to the adjusted timer.

In some implementations, network apparatus may configure a granularity of the timer information. The granularity of the timer information may comprise at least one of a time duration, a slot, a sub-slot, an OFDM symbol, and a fraction of the DRX cycle.

In some implementations, processor 612 may transmit, via transceiver 616, an acknowledgement in response to obtaining the timer information. The acknowledgement may be transmitted via one of UCI and an UL MAC CE.

In some implementations, the timer may comprise a retransmission timer or an inactivity timer.

In some implementations, processor 612 may adjust the timer according to a sign of the timer information.

In some implementations, the timer information is relative to a current value of the timer or a value in a DRX configuration.

### Illustrative Processes

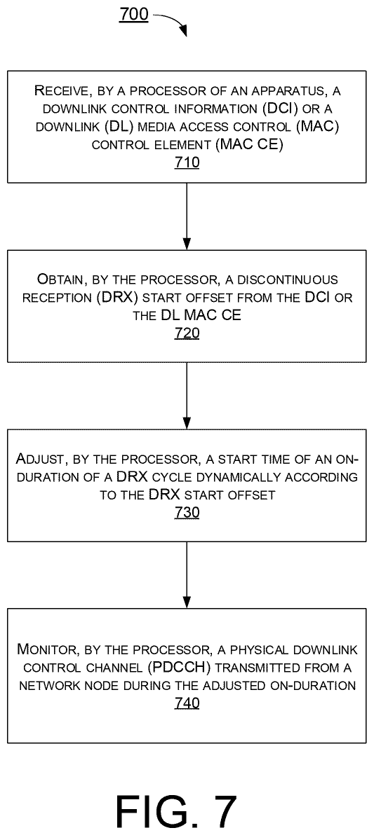

FIG. 7 illustrates an example process 700 in accordance with an implementation of the present disclosure. Process 700 may be an example implementation of schemes described above, whether partially or completely, with respect to enhanced DRX operation for XR and cloud gaming traffic with the present disclosure. Process 700 may represent an aspect of implementation of features of communication apparatus 610. Process 700 may include one or more operations, actions, or functions as illustrated by one or more of blocks 710, 720, 730 and 740. Although illustrated as discrete blocks, various blocks of process 700 may be divided into additional blocks, combined into fewer blocks, or eliminated, depending on the desired implementation. Moreover, the blocks of process 700 may executed in the order shown in FIG. 7 or, alternatively, in a different order. Process 700 may be implemented by communication apparatus 610 or any suitable UE or machine type devices. Solely for illustrative purposes and without limitation, process 700 is described below in the context of communication apparatus 610. Process 700 may begin at block 710.

At block 710, process 700 may involve processor 612 of apparatus 610 receiving a DCI or a DL MAC CE. Process 700 may proceed from block 710 to block 720.

At block 720, process 700 may involve processor 612 obtaining a DRX start offset from the DCI or the DL MAC CE. Process 700 may proceed from block 720 to block 730.

At block 730, process 700 may involve processor 612 adjusting a start time of an on-duration of a DRX cycle dynamically according to the DRX start offset. Process 700 may proceed from block 730 to block 740.

At block 740, process 700 may involve processor 612 monitoring a PDCCH transmitted from a network node during the adjusted on-duration.

In some implementations, process 700 may involve processor 612 performing a fallback operation in an event that DCI or the DL MAC CE with the DRX start offset is missed.

In some implementations, process 400 may involve processor 612 receiving DCI indicating an index of a DRX start offset look-up table and obtaining the DRX start offset from the DRX start offset look-up table according to the index.

In some implementations, process 700 may involve processor 612 adjusting the start time of the on-duration earlier or later according to a sign of the DRX start offset.

In some implementations, process 700 may involve processor 612 transmitting an acknowledgement in response to obtaining the DRX start offset.

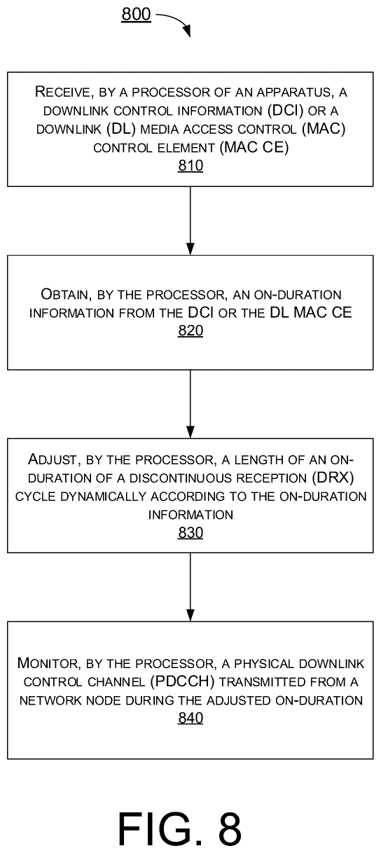

FIG. 8 illustrates an example process 800 in accordance with an implementation of the present disclosure. Process 800 may be an example implementation of schemes described above, whether partially or completely, with respect to enhanced DRX operation for XR and cloud gaming traffic with the present disclosure. Process 800 may represent an aspect of implementation of features of communication apparatus 610. Process 800 may include one or more operations, actions, or functions as illustrated by one or more of blocks 810, 820, 830 and 840. Although illustrated as discrete blocks, various blocks of process 800 may be divided into additional blocks, combined into fewer blocks, or eliminated, depending on the desired implementation. Moreover, the blocks of process 800 may executed in the order shown in FIG. 8 or, alternatively, in a different order. Process 800 may be implemented by communication apparatus 610 or any suitable UE or machine type devices. Solely for illustrative purposes and without limitation, process 800 is described below in the context of communication apparatus 610. Process 800 may begin at block 810.

At 810, process 800 may involve processor 612 of apparatus 610 receiving a DCI or a DL MAC CE. Process 800 may proceed from 810 to 820.

At 820, process 800 may involve processor 612 of apparatus 610 obtaining on-duration information from the DCI or the DL MAC CE. Process 800 may proceed from 820 to 830.

At 830, process 800 may involve processor 612 adjusting a length of an on-duration of a DRX cycle dynamically according to the on-duration information. Process 800 may proceed from 830 to 840.

At 840, process 800 may involve processor 612 monitoring a PDCCH transmitted from a network node during the adjusted on-duration.

In some implementations, process 800 may involve processor 612 receiving a plurality of data packets in a burst and obtaining the on-duration information from the last data packet of the data packets.

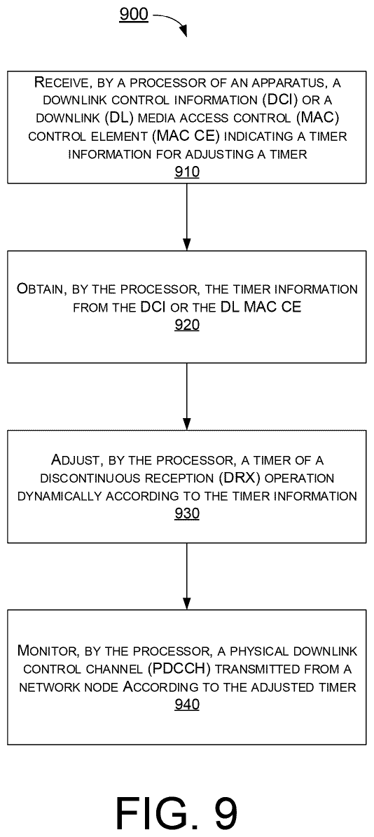

FIG. 9 illustrates an example process 900 in accordance with an implementation of the present disclosure. Process 900 may be an example implementation of schemes described above, whether partially or completely, with respect to enhanced DRX operation for XR and cloud gaming traffic with the present disclosure. Process 900 may represent an aspect of implementation of features of communication apparatus 610. Process 900 may include one or more operations, actions, or functions as illustrated by one or more of blocks 910, 920, 930 and 940. Although illustrated as discrete blocks, various blocks of process 900 may be divided into additional blocks, combined into fewer blocks, or eliminated, depending on the desired implementation. Moreover, the blocks of process 900 may executed in the order shown in FIG. 9 or, alternatively, in a different order. Process 900 may be implemented by communication apparatus 610 or any suitable UE or machine type devices. Solely for illustrative purposes and without limitation, process 900 is described below in the context of communication apparatus 610. Process 900 may begin at block 910.

At 910, process 900 may involve processor 612 of apparatus 610 receiving a DCI or a DL MAC CE indicating a timer information for adjusting a timer. Process 900 may proceed from 910 to 920.

At 920, process 900 may involve processor 612 of apparatus 610 obtaining timer information from the DCI or the DL MAC CE. Process 900 may proceed from 920 to 930.

At 930, process 900 may involve processor 612 adjusting a timer of a DRX operation dynamically according to the timer information. Process 900 may proceed from 930 to 940.

At 940, process 900 may involve processor 612 monitoring a PDCCH transmitted from a network node according to the adjusted timer.

In some implementations, process 900 may involve processor 612 transmitting an acknowledgement in response to obtaining the timer information.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, a downlink control information (DCI) or a downlink (DL) media access control (MAC) control element (MAC CE);
obtaining, by the processor, a discontinuous reception (DRX) start offset from the DCI or the DL MAC CE;
adjusting, by the processor, a start time of an on-duration of a DRX cycle dynamically according to the DRX start offset; and
monitoring, by the processor, a physical downlink control channel (PDCCH) transmitted from a network node during the adjusted on-duration.

2. The method of claim 1, further comprising:
performing, by the processor, a fallback operation in an event that the DCI or the DL MAC CE with the DRX start offset is missed.

3. The method of claim 2, wherein the fallback operation comprises using an existing DRX start offset, an earliest DRX start offset or a default DRX start offset.

4. The method of claim 1, further comprising:
receiving, by the processor, the DCI indicating an index of a DRX start offset look-up table; and
obtaining, by the processor, the DRX start offset from the DRX start offset look-up table according to the index.

5. The method of claim 1, wherein a granularity of the DRX start offset comprises at least one of a time duration, a slot, a sub-slot, an orthogonal frequency division multiplexing (OFDM) symbol, and a fraction of the DRX cycle.

6. The method of claim 1, wherein the adjusting comprises adjusting the start time of the on-duration earlier or later according to a sign of the DRX start offset.

7. The method of claim 1, further comprising:
transmitting, by the processor, an acknowledgement in response to obtaining the DRX start offset.

8. The method of claim 7, wherein the acknowledgement is transmitted via one of uplink control information (UCI) and an uplink (UL) media access control (MAC) control element (MAC CE).

9. The method of claim 1, wherein the DRX start offset is relative to a current on-duration of the DRX cycle or a current DRX configuration for the on-duration.

10. The method of claim 1, wherein a length of the on-duration or an end time of the on-duration is fixed.

11. A method, comprising:
receiving, by a processor of an apparatus, a downlink control information (DCI) or a downlink (DL) media access control (MAC) control element (MAC CE);
obtaining, by the processor, an on-duration information from the DCI or the DL MAC CE;
adjusting, by the processor, a length of an on-duration of a discontinuous reception (DRX) cycle dynamically according to the on-duration information; and
monitoring, by the processor, a physical downlink control channel (PDCCH) transmitted from a network node during the adjusted on-duration.

12. The method of claim 11, wherein the on-duration information comprises an on-duration timer.

13. The method of claim 11, wherein the DCI is a first DCI in the on-duration, and wherein the first DCI indicates the length of the on-duration.

14. The method of claim 11, wherein the DCI is a last DCI in a precious on-duration, and wherein the last DCI indicates the length of the on-duration.

15. The method of claim 11, further comprising:
receiving, by the processor, a plurality of data packets in a burst; and
obtaining, by the processor, the on-duration information from the last data packet of the data packets.

16. A method, comprising:
receiving, by a processor of an apparatus, a downlink control information (DCI) or a downlink (DL) media access control (MAC) control element (MAC CE) indicating a timer information for adjusting a timer;
obtaining, by the processor, the timer information from the DCI or the DL MAC CE;
adjusting, by the processor, a timer of a discontinuous reception (DRX) operation dynamically according to the timer information; and
monitoring, by the processor, a physical downlink control channel (PDCCH) transmitted from a network node according to the adjusted timer,
wherein the timer comprises a DRX retransmission timer or a DRX inactivity timer

17. The method of claim 16, wherein a granularity of the timer information comprises at least one of a time duration, a slot, a sub-slot, an orthogonal frequency division multiplexing (OFDM) symbol, and a fraction of the DRX cycle.

18. The method of claim 16, further comprising:
transmitting, by the processor, an acknowledgement in response to obtaining the timer information.

19. The method of claim 16, wherein the adjusting comprises adjusting the timer according to a sign of the timer information.

20. The method of claim 16, wherein the timer information is relative to a current value of the timer or a value in a DRX configuration.
